(19) United States
(12) Patent Application Publication
(10) Pub. No.: US 2014/0264969 A1
(43) Pub. Date: Sep. 18, 2014

(54) SINGLE-LAYER MEMBRANE COMPRISING POLYTETRAFLUOROETHYLENE INTERSPERSED THEREIN

(71) Applicant: Environmental Dynamics International, Inc., Columbia, MO (US)

(72) Inventors: Charles E. Tharp, Columbia, MO (US); Warrick S. Wadman, Columbia, MO (US); Randall C. Chann, Columbia, MO (US)

(73) Assignee: Environmental Dynamics International, Inc., Columbia, MO (US)

(21) Appl. No.: 14/205,032

(22) Filed: Mar. 11, 2014

Related U.S. Application Data
(60) Provisional application No. 61/799,197, filed on Mar. 15, 2013.

(51) Int. Cl. B01F 3/04; B29D 99/00

(52) U.S. Cl. CPC B01F 3/04269; B29D 99/005
USPC 261/100; 525/123; 264/154; 264/145

(57) ABSTRACT

A single-layer diffuser membrane constructed of first and second compounds. The first compound has structural and flexibility properties suitable for applying air to wastewater through a plurality of perforations formed through the membrane and the second compound is suitable for inhibiting fouling of the membrane. The first compound may comprise polyurethane and the second compound may comprise polytetrafluoroethylene. The concentration of the second compound within the membrane may be between about 3.0 vol. % and 20.0 vol. %. The second compound may be dispersed adjacent the perforations to inhibit fouling of the perforations. Another aspect of the present invention relates to the method for constructing the membrane. Upon the mixing of the first and second compounds, the mixed composition may be formed into a membrane through, for example, an extrusion process or a molding process. Perforations may be created either during or after the forming of the membrane.

### CROSS-REFERENCE TO RELATED APPLICATIONS

This application claims priority to U.S. Provisional Patent Application Ser. No. 61/799,197, filed on Mar. 15, 2013, to Charles E. Tharp et al. entitled “Single-Layer Membrane Comprising PTFE Interspersed Therein,” currently pending, the entire disclosure of which is incorporated herein by reference.

### BACKGROUND OF THE INVENTION

Flexible membrane diffusers have been used in the diffusion of gases into liquids, such as in the aeration of wastewater. The flexible membranes have been used with tubular, disc and panel diffusers. Examples of each a tubular membrane diffuser and a disc membrane diffuser are provided in U.S. Pat. No. 7,044,453 to Tharp.

Flexible membrane diffusers are conventionally constructed of rubber or a similar material which is punctured to provide a large number of perforations. It is known that, in the aeration of wastewater, the highest efficiency is achieved when the gas is released as fine bubbles. When gas is applied to the diffuser, the gas pressure expands the membrane away from a diffuser body and causes the perforations to open so that gas discharges through them in the form of fine bubbles. When the gas pressure is relieved, the membrane collapses on the diffuser body to close the perforations and prevent the liquid from entering the diffuser.

Although flexible membrane diffusers are advantageous in many respects and have achieved widespread acceptance in a variety of gas diffusion applications, they are not wholly free of problems. In a wastewater treatment application, materials in the liquid can become deposited and built up on the membrane to clog or partially clog the perforations and thus reduce the efficiency of the diffuser. For example, fats, oils, greases and other substances which are commonly found in wastewater can adhere to the membrane. Other substances, including gypsum, phosphorus, calcium and calcium compounds, such as calcium carbonate and calcium sulfate, are especially problematic when they precipitate and build up on the diffuser membrane. Biological growth biofilm, organic matter and inorganic matter can also build up on the membrane and compromise the diffuser efficiency. Diffuser membranes can also be chemically degraded by solvents and various other types of chemicals that may be present in the liquid. This chemical degradation combined with the repeated expansion and contraction of the membrane can weaken the membrane and cause premature structural failure.

One solution to these problems has been to apply a coating to the outer surface (of a tubular membrane) or the top surface (of a disc membrane) in order to provide the membrane with a relatively slick outer surface that resists biological growth and other substances and materials from being deposited thereon. However, the application of the coating is itself not without problems. It is often difficult to establish high bond strengths between the membrane's substrate layer and coating layer, in part, because of the non-adhesive qualities of the coating layer. Various methods have been proposed to address this problem. For example, the coating layer generally only includes a very low concentration (e.g., 3% to 5%) of the compound (e.g., polytetrafluoroethylene or PTFE) that provides the non-adhesive qualities. If higher concentrations are included, the coating layer may not sufficiently bond to the substrate layer.

Furthermore, the edges of the perforations formed into the membrane remain uncoated and therefore susceptible to buildup, clogging and fouling. In order for the perforations to extend through the entire membrane (i.e., through both the substrate layer and the coating layer), the membrane is not punctured until after the coating layer has been applied. As such, the edges of the perforations, the inner surface (of a tubular membrane) and bottom surface (of a disc membrane) remain uncoated.

There are many shortcomings in these existing configurations and the present invention is directed to overcoming one or more, if not all, of the above shortcomings.

### SUMMARY OF THE INVENTION

One embodiment of the present invention is directed generally to a single-layer flexible diffuser membrane adapted for applying air to wastewater for purposes of aerating the wastewater. The diffuser membrane may be in the form of a tubular membrane, disc membrane or panel membrane.

The diffuser membrane may comprise a first compound having structural and flexibility properties suitable for applying the air to the wastewater through a plurality of perforations formed through the membrane. The first compound may comprise, for example, polyurethane, ethylene propylene diene monomer (EPDM), natural rubber, nitrile rubber, butyl rubber, silicone rubber or combinations thereof. The diffuser membrane may comprise a second compound suitable for minimizing, inhibiting or entirely preventing fouling of the membrane. The second compound may comprise, for example, polytetrafluoroethylene (PTFE), perfluoroalkoxy (PFA), fluorinated ethylene propylene (FEP), silicones, fluoropolymers, acrylics or combinations thereof.

The concentration of the second compound (e.g., PTFE) in a composition forming the diffuser membrane may be between about 3.0 vol. % and 20.0 vol. % or more in one embodiment. The second compound may be generally uniformly dispersed with the first compound. In one preferred embodiment, the second compound is dispersed adjacent the perforations. The diffuser membrane may further include a biocide dispersed throughout the composition forming the membrane or applied thereto.

Another aspect of the present invention is directed to a composition used for forming the diffuser membrane.

A further aspect of the present invention is directed to a method of constructing the diffuser membrane. The method may include the steps of combining the first compound with the second compound; heating the first and second compounds; mixing the first and second compounds to form a resulting composition or mixture; forming the mixture into the membrane through at least one of an extrusion process, molding process, calendering process and thermoforming process; and perforating the membrane to provide a plurality of perforations extending therethrough.

Other aspects and advantages of the present invention will be apparent from the following detailed description of the preferred embodiments and the accompanying drawing figures.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a fragmentary perspective view of a portion of an aeration system for aerating wastewater that is equipped with a tubular diffuser having a flexible membrane constructed according to one embodiment of the present invention;

FIG. 2 is a fragmentary perspective view of a portion of an aeration system for aerating wastewater that is equipped with a disc diffuser having a flexible membrane constructed according to one embodiment of the present invention;

FIG. 3 is a fragmentary enlarged view of one of the perforations identified in FIG. 1 by detail 3;

FIG. 4 is a sectional view of the membrane on an enlarged scale taken generally along line 4-4 of FIG. 1 in the direction of the arrows, with the thickness exaggerated for purposes of illustration constructed according to one embodiment of the present invention; and

FIG. 5 is an enlarged fragmentary sectional view of a membrane that may be used with a disc or panel diffuser, with the thickness exaggerated for purposes of illustration constructed according to one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The entire disclosures of pending U.S. patent application Ser. No. 13/491,718, filed on Sep. Jun. 8, 2012 to Warrick S. Wadman, et al. entitled “Diffuser Membrane and Method of Manufacture” and U.S. Provisional Application Ser. No. 61/495,830, filed on Jun. 10, 2011 to Charles E. Tharp entitled “Diffuser Membrane and Method of Manufacture” are incorporated herein by reference.

The present invention is directed to a flexible diffuser membrane, a composition for forming a flexible diffuser membrane, and a method of constructing a flexible diffuser membrane. Membranes of this type are used in a variety of applications in which gases of various types are diffused into liquids of various types. One example is a wastewater treatment system in which flexible membrane diffusers are commonly used to diffuse air into wastewater for aeration and mixing purposes. Flexible membrane diffusers are used in this type of application on tubular diffusers, disc diffusers and panel diffusers.

While FIG. 1 depicts a tubular membrane diffuser generally identified by numeral 10, it is to be understood that the invention is equally applicable to membranes for disc diffusers, panel diffusers and other types of diffusers that are used both in water and wastewater treatment as well as in the diffusion of various types of gases into other liquids.

The diffuser 10 can be used in an aeration system which includes a variety of air lateral pipes such as the pipe 12 which may be floating on the surface of the liquid or submerged. Air or another gas is supplied to the pipe 12 and is discharged into a tee-fitting 14 connected with a saddle structure 16 used to mount the diffuser assembly on the pipe 12. FIG. 1 depicts tubular diffusers extending from each of the side outlets of the tee-fitting 14 (one shown only fragmentarily), although other arrangements are possible. Diffuser systems and structures different from what is shown in FIG. 1, including those described and shown in U.S. Patent Application Publication No. 2012/0061862 and those making up Environmental Dynamics International Inc.'s StreamLine™ system, are within the scope of the invention.

As shown in FIG. 1, the diffuser 10 includes a hollow rigid diffuser body 18 which is connected with an outlet of the tee-fitting 14 and extends generally horizontally. The diffuser body 18 is provided with one or more openings (not shown) which discharge the gas within a flexible tubular membrane 20 secured to the diffuser body 18 by band clamps 22 or other suitable fasteners. The membrane 20 is provided with a plurality of small pores or perforations 24 which may take the form of slits or holes arranged in any desired pattern.

When air is applied to the diffuser body 18 from the lateral pipe 12, the gas pressure causes the membrane 20 to expand from the diffuser body 18, thus opening the perforations 24 and discharging the gas through the perforations into the liquid in the form of fine or coarse bubbles which are beneficial in that they efficiently transfer the gas to the liquid. When the gas pressure is relieved, the flexible membrane 20 collapses back onto the diffuser body 18 and thus closes the perforations 24 so that the liquid is unable to leak into the diffuser 10.

FIG. 2 illustrates a disc diffuser 44 comprising a holder having a retaining ring 46 for retaining a disc membrane 40. Like diffuser 10, when air is applied from the lateral pipe 12, the gas pressure causes the membrane 40 to expand, thus opening the perforations 24 and discharging the gas through the perforations into the liquid in the form of fine or coarse bubbles which are beneficial in that they efficiently transfer the gas to the liquid. When the gas pressure is relieved, the flexible membrane 40 collapses, thus closing the perforations 24 so that the liquid is unable to leak into the diffuser 44.

One aspect of the present invention is directed specifically to the construction of the membrane 20 and 40. As best shown in FIGS. 4 and 5, the method described herein may be used in constructing membranes 20 having a tubular shape and membranes 40 that may be of a generally flat or disc shape. In one preferred embodiment, the membranes 20 and 40 are each constructed of a single layer 26 and 42 of material, respectively. The single layer 26 and 42 is formed from a mixture of two or more compounds. The single layer membrane 20 or 40 may comprise a first compound having structural properties and flexibility properties suitable for applying air to wastewater through a plurality of perforations 24 formed through the membrane 20 or 40. The first compound preferably results in the membrane 20 or 40 having elastomeric or rubber-like characteristics and qualities. The single layer membrane 20 or 40 may also comprise a second compound having non-adhesive qualities and a low coefficient of friction in order to minimize, inhibit or entirely eliminate fouling of the membrane 20 or 40. The second compound, as generally represented by dots 56 in FIGS. 3-5, is preferably dispersed throughout at least a portion of the first compound, as generally represented by 58 in FIGS. 3-5. In one embodiment, the second compound is generally uniformly dispersed, mixed or distributed through the first compound. In one embodiment, the membrane 20 or 40 may be defined by the following properties: tear resistance (Type C) of about 400 pounds per inch; tensile strength of about 4,000 pounds per square inch; ultimate elongation of about 500%; Shore A hardness of about 90; water absorption less than about 0.8%; and a flex test of over 2,000,000 cycles. It will be understood that these properties are not meant to be limiting in any regard and are provided simply as examples. Membranes having other physical properties are within the scope of the present invention and may be implemented in various scenarios depending upon the condition of the water to be treated and the environment and system in which the membrane 20 or 40 is implemented.

Examples of materials that are suitable for use in the first compound include polyurethane, ethylene propylene diene monomer (EPDM), natural rubber, nitrile rubber, butyl rubber, silicone rubber, other suitable polymers and flexible materials having the necessary qualities and combinations thereof. Examples of materials that are suitable for use in the second compound include polytetrafluoroethylene (PTFE or Teflon®), perfluoroalkoxy (PFA), fluorinated ethylene propylene (FEP), silicones, fluoropolymers, acrylics, any other suitable material and polymers having relatively low coefficients of friction and combinations thereof. In one embodiment, the first compound comprises polyurethane and the second compound comprises PTFE.

As set forth above, the second compound is suitable for minimizing, inhibiting, hindering, deterring or entirely eliminating fouling that may otherwise occur with respect to the membrane 20 or 40. For purposes of the present invention, it will be understood that “fouling” refers to the depositing, adhering or building up of various substances on the membrane 20 or 40 and/or the chemical or physical degradation of the membrane 20 or 40. Such substances may include; but are not limited to, fats, oils, greases, gypsum, calcium, calcium compounds (such as calcium carbonate and calcium sulfate, for example), phosphorus and other substances commonly found in wastewater. Such substances may also include solvents and other chemicals often found in wastewater. Such substances may further include biological growth, biofilm, organic matter and inorganic matter that may be present in the wastewater. In addition to becoming deposited or built up on the membrane 20 and 40, these substances can cause the perforations 24 to become clogged or partially clogged, thus reducing the efficiency of the diffuser. The chemical or physical degradation of the membrane 20 or 40 may be caused by solvents and various other types of chemicals or substances that may be present in the wastewater. This degradation combined with the repeated expansion and contraction of the membrane 20 or 40 can weaken the membrane 20 or 40 and cause premature structural failure.

In addition to the first and second compounds discussed above, the membranes 20 and 40 may optionally be impregnated or otherwise treated with a biocide agent in order to protect the edges 30 and 32 of perforations 24 from the buildup of biological growth and other deposited materials. The biocide may be dispersed through the composition made up of the first and second compounds. The entire disclosure of U.S. Pat. No. 6,543,753 to Charles E. Tharp entitled “Air Diffuser Membrane Treated with Biocide,” is incorporated herein by reference.

The membranes 20 and 40 may be formed through, for example, an extrusion process, molding process, calendering process, thermoforming process or any other suitable process. The tubular membranes 20 may formed in an extrusion process, whereas the disc membranes 40 may be typically formed in a molding process or calendering process.

Prior to the formation of the membrane 20 or 40, the second compound (e.g., PTFE) is blended, dispersed, interspersed or otherwise mixed with the first compound (e.g., polyurethane). This may occur in a heated environment. In one embodiment, the second compound is generally uniformly dispersed throughout the membrane. By dispersing the second compound directly into the first compound, as opposed to applying it as part of a coating or layer, the concentration of the second compound may be greater, as issues with bonding two separate material layers together are eliminated. The concentration of the second compound in the composition may be between about 3.0 vol. % and 20.0 vol. % or more in one embodiment. More or less of the second compound may be included depending upon the specific application, potential for buildup and fouling, along with a number of other considerations including integrity, strength, and cost. Accordingly, it will be appreciated that the composition forming the membrane 20 or 40 may include from about 0.1 vol. % to about 99.9 vol. % PTFE in one embodiment and from about 3.0 vol. % and 20.0 vol. % PTFE or more in another embodiment.

Because the second compound (e.g., PTFE) is generally dispersed throughout the membranes 20 and 40, the inner and outer surfaces 48 and 50 of membrane 20 are thereby treated with the second compound and the top and bottom surfaces 52 and 54 of membrane 40 are also treated with the second compound. Further yet, due to the second compound being generally dispersed throughout the membranes 20 and 40, the perforations 24 are also thereby treated with the second compound. In other words, the second compound can be dispersed adjacent surfaces 48, 50, 52 and 54 and perforations 24 thereby protecting surfaces 48, 50, 52 and 54 and the perforations 24 from the buildup of substances such as fats, oils, greases, gypsum, calcium, calcium compounds (such as calcium carbonate and calcium sulfate, for example), phosphorus, biological growth, biofilm, organic matter, inorganic matter and other substances commonly found in wastewater. It may also protect the surfaces 48, 50, 52 and 54 and perforations 24 from chemical degradation caused by solvents and various other types of chemicals that may be present in wastewater. The walls or edges 30 and 32 of the perforations 24 extending through the membrane 20 are formed, at least in part, of the second compound, which again may be PTFE.

It will be appreciated that the addition of the second compound (e.g., PTFE) to the first compound may increase the membrane's 20 or 40 resistance to relatively high temperatures. It will be appreciated that the composition forming the membrane 20 or 40 may include a concentration of PTFE suitable for enhancing the diffuser membrane's resistance to damage and degradation at elevated temperatures. As the concentration of PTFE is increased, the membrane's 20 or 40 temperature resistance is also increased, and in some cases increased significantly. This is particularly beneficial when the membrane 20 or 40 is used in the treatment of hot wastewater. An increased concentration of PTFE can also result in increased structural properties as well.

Turning now to the method of constructing the membrane 20 or 40, it will be appreciated that the first compound may be combined with the second compound. In that regard, it will be understood that the first compound may be added to the second compound or that the second compound may be added to the first compound. Additional compounds or chemicals may be added to the first and/or second compounds before, simultaneously with, or after the first and second compounds are combined with one another. The first and second compounds may then be mixed to form a resulting mixture or composition. The first and second compounds are optionally heated to a specified temperate either before or during the mixing step.

The mixture can then be formed into a membrane 20 or 40 through an extrusion process, molding process, thermoforming process or any other suitable process now known or hereafter developed. The mixture can also be applied to a flat or contoured surface such that, upon cooling and setting up, it may be peeled therefrom in the form of a membrane or sheet. A plurality of perforations 24 extending through the membrane 20 or 40 may be formed either during or after the forming process. When the perforations are formed after the forming process, the perforations 24 may be created by puncturing, perforating or cutting the membrane 20 or 40. Subsequent to the forming process, the membranes 20 or 40 may be cut or trimmed to size, as applicable. It will be appreciated that the steps disclosed herein may be undertaken in close temporal proximity with one another or may be undertaken at different times and even in different facilities.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A flexible diffuser membrane for applying air to wastewater for aeration of the wastewater, said diffuser membrane comprising:
a first compound having structural and flexibility properties suitable for applying said air to said wastewater through a plurality of perforations formed through said membrane; and
a second compound dispersed throughout said first compound, said second compound being suitable for inhibiting fouling of said membrane.

2. The diffuser membrane of claim 1, wherein said diffuser membrane is constructed of a single-layer of material.

3. The diffuser membrane of claim 1, wherein said first compound is selected from a group consisting of polyurethane, ethylene propylene diene monomer (EPDM), natural rubber, nitrile rubber, butyl rubber, silicone rubber and combinations thereof.

4. The diffuser membrane of claim 1, wherein said second compound is selected from a group consisting of polytetrafluoroethylene (PTFE), perfluoroalkoxy (PFA), fluorinated ethylene propylene (FEP), silicones, fluoropolymers, acrylics and combinations thereof.

5. The diffuser membrane of claim 1, wherein said first compound comprises polyurethane and said second compound comprises polytetrafluoroethylene (PTFE).

6. The diffuser membrane of claim 5, wherein said PTFE is generally uniformly dispersed throughout said polyurethane.

7. The diffuser membrane of claim 1, wherein said second compound comprises polytetrafluoroethylene (PTFE).

8. The diffuser membrane of claim 7, wherein said diffuser membrane is formed of a composition comprising a concentration of between about 3.0 vol. % and 20.0 vol. % PTFE.

9. The diffuser membrane of claim 7, wherein said wherein said diffuser membrane is formed of a composition comprising a concentration of PTFE suitable for enhancing said diffuser membrane's resistance to degradation at elevated temperatures.

10. The diffuser membrane of claim 7, wherein said PTFE is dispersed adjacent said perforations.

11. The diffuser membrane of claim 1, wherein said second compound is generally uniformly dispersed throughout said first compound.

12. The diffuser membrane of claim 1, wherein said diffuser membrane is a tubular membrane.

13. The diffuser membrane of claim 1, wherein said diffuser membrane is a disc membrane.

14. The diffuser membrane of claim 1, wherein said diffuser membrane is formed of a composition comprising said first and second compounds and wherein a biocide is dispersed throughout said composition.

15. A composition for forming a flexible diffuser membrane for applying air to wastewater for aeration of the wastewater, said composition comprising:
a first compound having structural and flexibility properties suitable for applying said air to said wastewater through a plurality of perforations formed through said membrane; and
a second compound dispersed throughout said first compound, said second compound being suitable for inhibiting fouling of said membrane.

16. The composition of claim 15, wherein said second compound comprises polytetrafluoroethylene (PTFE).

17. The composition of claim 16, wherein said composition comprises a concentration of between about 3.0 vol. % and 20.0 vol. % PTFE.

18. The composition of claim 16, wherein said composition comprises a concentration of PTFE suitable for enhancing said diffuser membrane's resistance to degradation at elevated temperatures.

19. A method for constructing a flexible diffuser membrane for applying air to wastewater for aeration of the wastewater, said method comprising the steps of:
providing a first compound having structural and flexibility properties suitable for applying said air to said wastewater through a plurality of perforations formed through said membrane;
providing a second compound suitable for inhibiting fouling of said membrane;
combining second first compound with said second compound;
mixing said first and second compounds to form a resulting mixture;
forming said mixture into said membrane; and
perforating said membrane to provide said plurality of perforations extending through said membrane.

20. The method of claim 19, wherein said membrane is a single-layer membrane.

21. The method of claim 19 further comprising a step of heating said first and second compounds.

22. The method of claim 19, wherein step of forming said mixture into said membrane is achieved through at least one of an extrusion process, molding process, calendering process and thermoforming process.
